(19) United States
(12) Patent Application Publication
(10) Pub. No.: US 2004/0044544 A1
(43) Pub. Date: Mar. 4, 2004

(54) System and method for providing information technology management services

(76) Inventors: Brad Smith, Austin, TX (US); John Kershner, Houston, TX (US); June Zeplin, Houston, TX (US)

Correspondence Address: D'AMBROSIO & ASSOCIATES, P.L.L.C., 10260 WESTHEIMER, SUITE 465, HOUSTON, TX, 77042, US

(21) Appl. No.: 10/652,289

(22) Filed: Aug. 29, 2003

Related U.S. Application Data
(60) Provisional application No. 60/407,151, filed on Aug. 30, 2002.

(51) Int. Cl. G06F 17/60

(52) U.S. Cl. 705/1

(57) ABSTRACT

The system and method for providing information technology management services comprise a web site hosted by one or more servers, a web based software management system for accessing stored information technology management softwares, interactive IT management software programs, modules, templates and models, and a communication network system for linking access devices to the host server. The IT management softwares include an IT planning software, an IT purchasing software, an IT managing software, an IT optimizing software, company information softwares, and IT vendor softwares. Additionally, the present system includes data structure software for structuring the data within the information technology management softwares according to one or more interactive modules. The modules include an advice module, an intelligence module, a web tools module and a project support module.

### RELATED APPLICATIONS

This application claims priority from co-pending U.S. Provisional Application No. 60/407,151 filed Aug. 30, 2002, the full disclosure of which is hereby incorporated by reference herein.

### FIELD OF THE INVENTION

The present invention relates to a system and method for providing information technology management support. More particularly, the invention relates to a system and method for providing interactive online support for information technology management.

### BACKGROUND OF THE INVENTION

With information technology (IT) an increasingly intrinsic part of business operations, the role cast for information technology executives and Chief Information Officers (CIO) has grown exponentially. The CIO or IT manager's duties and responsibilities encompass both organization and leadership of technology and staff that affects every area of a company from the mail room to the board room.

In recent years, as IT use has grown more widespread and ingrained, permeating almost every aspect of every enterprise, the CIO's job has become increasingly sophisticated and complex. Add to that the ever more critical role information technology plays in setting corporate strategy and overseeing emerging technologies, and the responsibilities of a CIO are almost too great for a lone executive. Many organizations are forced to divide up IT management positions into two or more jobs. With these considerations in mind, many small to medium sized companies cannot afford to hire a CIO. Salaries of CIO's often exceed six figures. An expense far too great for these smaller sized companies.

The problems of not being able to afford a CIO and/or staff has not been addressed by prior art for small to medium sized companies. Most prior art relate to methods of providing financial services to customers. Bornemisza-Wahr et al., in U.S. Pat. No. 6,073,119 discloses a method and system for a banking institution interactive center. This invention includes a banking facility layout and a method and system for networked customer interaction with a variety of functions. These functions include access to networks, such as the internet, email capability, options to view information on banking capabilities, access to home banking, and other electronically-related user functions. The invention incorporates a purpose-designed environment that can be integrated into a branch or other banking institution facility. A video wall is provided that allows interaction by networked users. The interaction area including a shared network video device and a terminal. The method for a user to obtain interactive information services on a first network in an interaction area comprises

1. enrolling the user for access to the interaction area;

2. issuing the user key access to the interaction area;

3. the user inputting the key access at the interaction area;

4. the user logging on to the terminal on the network;

5. associating a connection time limit with the key access;

6. limiting the user access time to the connection time limit;

7. providing the logged on user with a selection of interactive information services,

8. the user selecting an interactive information service; and the user interacting with the interactive information service.

Lee et al., in U.S. Pat. No. 2002/0069,168, Bennett et al., in U.S. Pat. No. 2002/0049,655 and Kihl et al., in U.S. Pat. No. 6,222,536 describe various systems and methods for providing financial services via the Internet. Zeanah et al., in U.S. Pat. No. 5,933,816 relates to a delivery system and method that allows a financial institution to provide financial services from remote locations including ATM's and external service providers.

Schein et al. in U.S. Pat. No. 2001/0018,674 teach a global messaging system and process for allowing customers to access a full range of global financial services using a variety of access points. A database assembled from diverse sources and systems and processes for retrieving the information from the central database are included. The system discloses levels of access communications as well as built-in flexibility so that it can be accessed by a variety of remote systems of varying degrees of complexity and languages.

Northington et al., in U.S. Pat. No. 6,128,602 disclose an open-architecture system that automatically consolidates information from many financial systems into a single accounting system. Calver, in patent application, U.S. Pat. No. 2001/0032,092, discloses a Small Business Web-Based Portal Method and System. The method and system interactively provides user-tailored information to a user via a web-based portal. The remote computer network has clients connectable to one or more servers. Initially, user-provided information is compiled via an interactive template within the web-based portal. Thereafter, the interactive electronic template and the user-provided information are automatically analyzed to obtain resulting user-tailored information. The user-tailored information is then interactively rendered in a web browser The web-based portal can be implemented as a Small Business Web Portal so that user-tailored financial and business information can be interactively rendered for a user, based on user-provided financial and business information.

None of the referenced patents teach or suggest a web-based IT management support system having the unique functions and methods described below.

### SUMMARY OF THE INVENTION

Advantageously, this invention's on-line system and method provides information technology management support for various industries. It is beneficial to small companies that cannot employ an IT manager as well as large companies having a Chief Information Officer but requiring additional management assistance with its IT program. The IT management system and method provided by this invention includes databases, models, software programs and modules that cover almost every aspect of IT management from strategic planning to purchasing negotiations and contracts to optimization of computer equipment and personnel. Many of these programs are interactive for customizing to the user's particular technology task.

Preferably, the system utilizes a website hosted by a server; the web site comprises one or more information technology management software modules and/or databases connected by one or more internet access devices capable of accessing data stored on a host server. The present invention employs a communication network system for linking the access devices to the host server(s). One preferred system further contains a software management system for accessing one or more stored information technology (IT) management modules. Another preferred system and method of this invention comprises software modules including at least one strategic technology software module, at least one infrastructure technologies software module, at least one risk and regulatory management software module, and at least one IT management software module.

Advantageously the IT management software modules can comprise implementation of new technology data; management of existing technology data; data for management of IT plans and budgets, IT policies and procedures data, data for implementation of system upgrades and new releases, data for managing LANs, WANs, Datacomm, and Telecomm, data for managing systems capacity and availability, data for tracking and controlling IT assets, data for managing EDP Auditors and Regulators, data for manage Security and Risk, data for the management of vendors, end user IT support data, data for recruiting and training IT staff. The one or more strategic technologies software modules can comprise industry specific software for the evaluation, selection, installation and utilization of industry specific technologies.

In one preferred embodiment, the system of the present invention is applied to the financial services industry and the software comprises financial institution specific technologies comprising Internet banking, core accounting, CRM and cash management. The one or more infrastructure technologies software modules noted may comprise software for the design, selection, installation and utilization of network, telecom, and datacom infrastructure technologies. Further, the at least one risk and regulatory management software modules can comprise IT risk management software, management of regulatory compliance software, and management of regulatory compliance data, information, or topics.

The one or more IT management software modules can include IT planning software, IT budgeting software, IT vendor management software IT vendor management software, IT cost control software, and IT cost control data, information, or topics.

Advantageously, the scope of the present invention includes one or more components to support the one or more information technology management software modules where the one or more components comprise reports, peer exchange, solution sourcing, tools, advice and support and combinations thereof.

The peer exchange component can comprise software for the exchange of industry specific IT management information, practices, documents, methodologies and templates by industry members. The solution sourcing component of the present invention preferably comprises decision making informational data regarding IT matters.

The present invention also includes a method for providing information technology management services. One preferred method comprises providing a web site comprising one or more information technology management software modules, accessing the web site using one or more internet access devices, accessing a software management system located on the web site. The software management system of the preferred method comprises information technology management software modules. The method of the present invention can further comprise supporting an information technology program based on data provided by the information technology management software modules; and communicating with information technology management consultants for optimizing the support of the IT managing software.

In the preferred method of the present invention, accessing the web site comprises using a communications network system comprising a local area network system as well as the Internet. The method of the present invention further includes means for authenticating authorized users, a dedicated web server, encryption means, as well as a telephony gateway adapted to route telephone calls through the communications network system.

The information technology management software modules of the preferred method comprise one or more strategic technologies software modules, one or more infrastructure technologies software modules, one or more risk and regulatory management software modules and one or more IT management software modules. Also included are components to support the one or more information technology management software modules. Preferably, the one or more components comprise reports, peer exchange, solution sourcing, tools, advice and support and combinations thereof.

Advantageously, the present invention also provides a cost effective tool to allow small to medium sized companies to compete with larger companies by providing input and feedback in the overall information technology strategy and budgeting. The databases and modules of this invention can guide a user to set budget priorities, manage and safeguard key data, communications, hardware and software.

### BRIEF DESCRIPTION OF DRAWINGS

FIGS. 1-4 illustrate exemplary website screens used in the practice of this invention.

### DETAILED DESCRIPTION OF INVENTION

The method and system of this invention is applicable to a wide array of companies, industries, businesses and organizations that have sufficient information technology to require executive management know how and services. When using the IT management system and services, companies obtain the information, data, strategic planning, management and decision-making tools typically provided by a CIO or IT executive, i.e., a virtual IT manager. For illustrative purposes only, without further limitation, this detailed description will be directed towards institutions providing financial services including the banking industry, savings banks, credits unions and other similar institutions.

One preferred embodiment of the present invention comprises a web based system that provides information technology management support. The core of the system is a web site containing one or more information technology management software modules accessible to authorized users. The web site further includes one or more internet access devices for accessing data stored on a host server, a communications network system for linking the one or more internet access devices to the one or more host servers, and a software management system for accessing the one or more stored information technology management software modules.

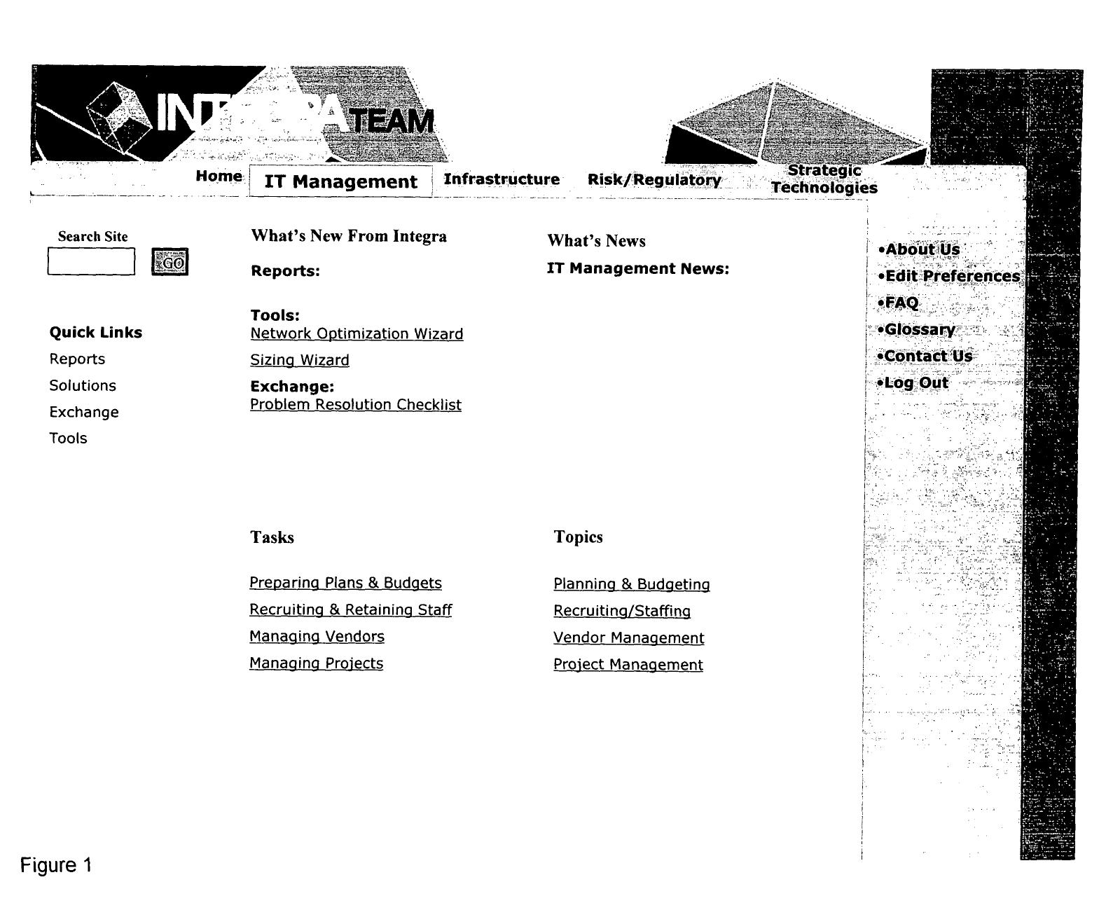

Each module of this embodiment contains accessible content to be utilized to aid in the management, development, and maintenance of an organization's IT system. As will be described in more detail below, each module of the preferred embodiment of the present invention addresses a different aspect with regard to an IT system. Preferably the software modules of the present invention include one or more strategic technologies software modules, one or more infrastructure technologies software modules, one or more risk and regulatory management software modules and one or more information technology (IT) management software modules. FIGS. 1-4 illustrate exemplary web site screens for accessing the various software modules.

In the preferred embodiment of the present invention, as illustrated in part in FIG. 1, the IT management software modules include information dealing with implementation of new technology data as well as management of existing technology data. In one aspect, the IT managements software modules can also comprise data for management of IT plans and budgets, IT policies and procedures data, data for implementation of system upgrades and new releases, data for managing LANs, WANs, Datacomm, and Telecomm, data for managing systems capacity and availability, data for tracking and controlling IT assets, data for managing EDP Auditors and Regulators, data for manage Security and Risk, cost control, data for the management of vendors and vendor relations, end user IT support data, and data for recruiting and training IT staff. The IT management software modules can further comprise IT planning software, IT budgeting software, IT vendor management software IT vendor management software, IT cost control software, and IT cost control data, information, or topics.

FIG. 1 is a web site screen accessing IT management software and data. It has click-on access to information and data regarding various tasks, preparing plans and budgets, for example, as well as software programs for accomplishing the task as listed under “Topics”. The “how to” software for doing an actual plan or Budget is listed under “Topics”. Also accessible from this web page are various news items regarding IT management, new software and databases presently available online and links to various components for implementing the system's features.

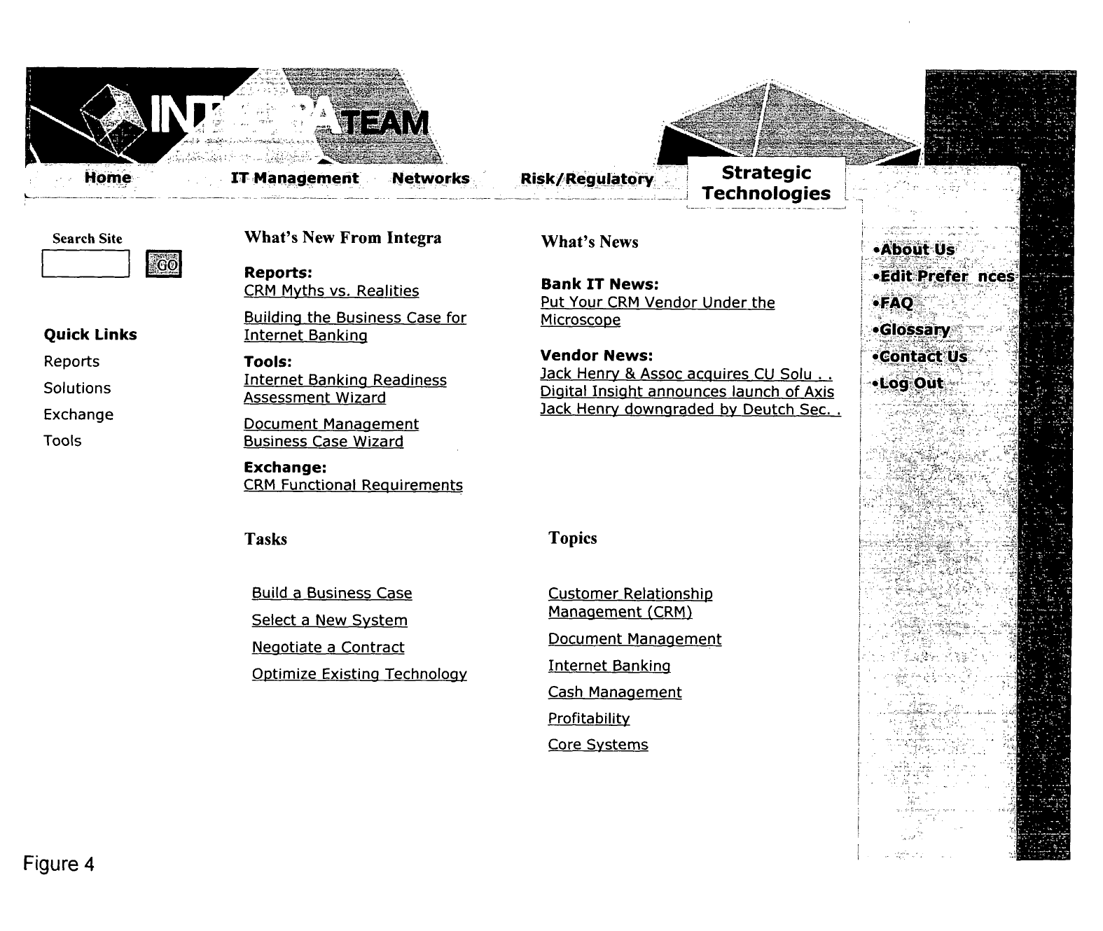

In one preferred embodiment of the present invention, as illustrated in FIG. 4, the one or more strategic technologies software modules comprise industry specific software for the evaluation, selection, installation and utilization of industry specific technologies. The subject industry considered for this described embodiment of the invention is financial services. The strategic technologies software module addresses the design, selection, installation, and utilization of community and specific technologies, such as Internet banking, core accounting, Customer Relationship Management (CRM), and cash management.

As in the previous screen, this web page screen illustrated in FIG. 4 includes new information, data and software available to the user by the IT system, newsworthy articles regarding strategic technologies as well as information and data regarding specific tasks and programs designed to help the user accomplish a specific task or topic, how to accomplish document management or Internet Banking for example.

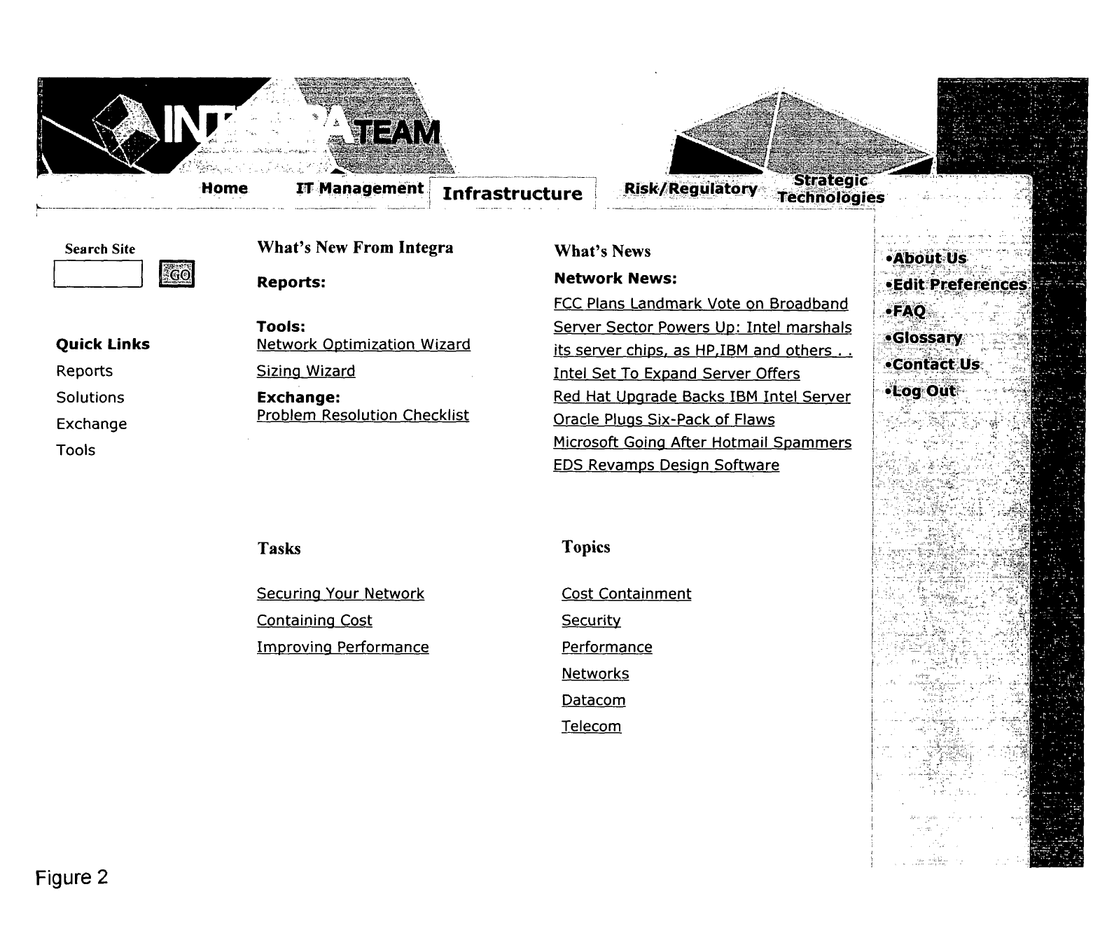

FIG. 2 illustrates a web page to access the one or more infrastructure technologies software modules of the present invention. These software modules can comprise software for the design, selection, installation and utilization of network, telecom, and datacom infrastructure technologies. Included in the task can be information and data regarding securing a network, containing costs and improving performance.

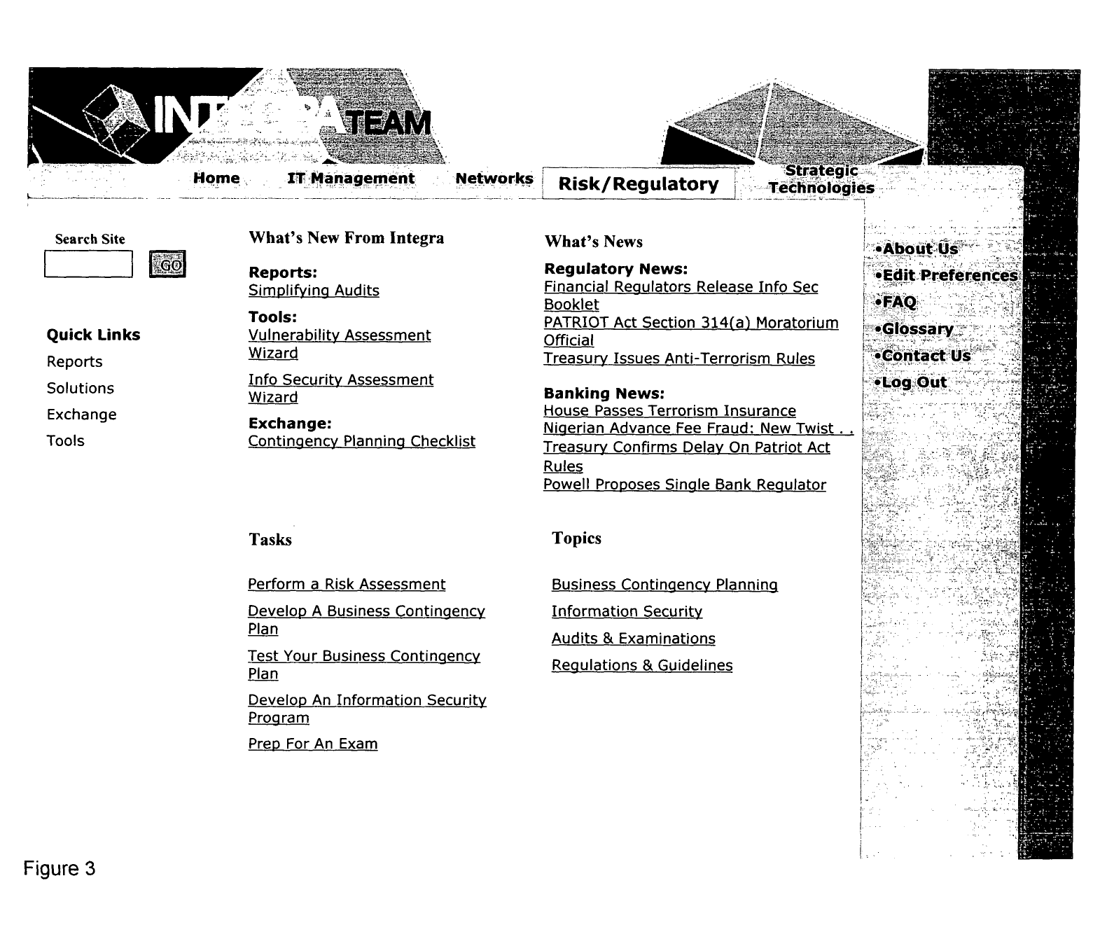

The risk and regulatory management software modules of one embodiment of the present invention can comprise IT risk management software, management of regulatory compliance software, and management of regulatory compliance data, information, or topics. The risk and regulatory module further includes the flexibility to assess risk in light of the changing regulations that affect financial institutions as well as protection against unauthorized users from entering the system. FIG. 3 illustrates a typical web page for accessing information and data regarding this module.

The system of the present invention further comprises components to implement and support the information technology management software modules. These components comprise intelligence reports, research reports, peer exchange, solution sourcing, tools, advice and support and combinations thereof. The reports component of the software modules preferably includes research reports regarding IT management. Research reports are prepared that contain information on critical technologies. This information serves to educate representatives or agents of financial institutions, including banks, and provide them with information and data to aid them in their decision making in regarding technology matters. The intelligence and research reports can further contain critical information on the technologies supplied by the various vendors so the personnel referencing the report can compare the technologies in order to choose the optimum technology for a specific application.

The peer exchange component of the software modules comprises software for the exchange of industry specific IT management information, practices, documents, methodologies and templates by industry members. Here intellectual capital and best practices can be shared through a facilitated online, members only, exchange of documents, methodologies and templates within a dedicated customer base.

The solution sourcing component of the software modules comprises decision making informational data regarding IT matters. For example, in instances where a purchase is to be made of hardware, software, or professional services, the solution sourcing component of the present invention can provide a referral to entities capable of providing such services or hardware. Furthermore, the solution sourcing component is also capable of compiling and reflecting member satisfaction ratings as well as the ability to negotiate discounts for a purchaser. The tools component of the software modules comprises decision support software.

Additionally, the advice and support component of the software modules comprises customer support in variety of ways such as; online, telephonic or in-person support. The customer support component can include professional technology advisors and coaches who are capable of fielding product related questions and usage, as well as serve as a resource when additional research is required. A customer can communicate with an advisor via email, telephone or, if necessary, on site visits.

The one or more internet access devices considered within the scope of the present invention include P.C's, computer terminals, hand held computers, Web T.V., wireless Internet access devices, mobile Internet access devices and combinations thereof. The communications network system of the present invention includes a local area network system and accessing the World Wide Web (WWW) via the Internet. The system of the present invention further comprises an authorization system for authenticating authorized users.

One embodiment of the present invention also includes a method for providing information technology management services. The method comprises providing a web site having one or more information technology management software modules, accessing the web site using one or more Internet access devices, accessing a software management system located on the web site, supporting an information technology program based on data provided by the information technology management software modules, and communicating with information technology management consultants for optimizing the support of the IT managing software. The software management system of this method comprises information technology management software modules.

In the method of the present invention, the step of accessing the web site involves using a communications network system comprising a local area network system as well as the Internet. The method of the present invention preferably includes a method for authenticating authorized users as well as encryption. Preferably the website of the method of the present invention comprises a dedicated web server. Also preferably, the method of the present invention includes a telephony gateway adapted to route telephone calls through the communications network system.

The information technology management software modules of the method of the present invention comprise one or more strategic technologies software modules, one or more infrastructure technologies software modules, one or more risk and regulatory management software modules and one or more IT management software modules. The preferred method further includes one or more components to support the one or more information technology management software modules, where the components comprise reports, peer exchange, solution sourcing, tools, advice and support and combinations thereof.

In another preferred system for providing information technology management services, the system comprises a web site hosted by one or more servers. The web site can comprise one or more information technology management databases, software programs, modules, models, and templates. These various aspects of the IT management system can be organized into broad categories or modules that are accessible to an authorized user. Data structure software structures the data within the information technology management system according to one or more interactive modules.

One advice module has interactive data and programs regarding IT steering committees, overview committees, and corporate boards. Templates are provided for documents required by these committees such as agendas, minutes, meeting schedules and calendars. In one aspect, the advice module is an interactive module also comprising links. The links comprise online connections to discussion groups, formats for submitting questions to IT management consultants, and a frequently asked questions site. The advice module can be customized for the authorized user. One or more communication accessories are provided to facilitate communication between an authorized user of the advice module and one or more IT management consultants. The communication accessories are well known in the art and include a Web cam, an Instant Messaging program and combinations thereof. The advice module can further comprise telephone and email contact information enabling the authorized user to contact an IT management consultant.

An intelligence module provides information data important to IT managers such as IT management research reports, IT government rules and regulations, IT management news items, and IT advisory management reports. The available reports can be categorized into planning intelligence, purchasing intelligence and optimizing intelligence for managing and optimizing a company's computer technology and human resources. In one aspect, the reports can be proprietary reports written by the owners of the web site, alternatively they can be public accessable information.

A web tools module, comprises software programs and databases for implementing IT management. Web tools are basic how-to software programs and databases for various management aspects of IT. The web tools can comprise asset management software programs and databases, contract management software programs and databases, training development software and databases, and project management software programs and databases. The web tools module further comprises planning and policy-making tools, managing people and assets tools, alerting tools, planning, purchasing and managing how-to tools, reporting tools and combinations thereof.

The project support module also comprises means for interactive user support. Project support screens can take the user though every stage required for an IT project, from planning for IT needs within a company to purchasing, negotiating and administering IT contracts to managing the technology and people who run it and finally, optimizing the IT system. Also included are specifics of contract management, training and development and a complete management how-to for running a project. Other projects are know in the art and may be specific to individual users.

Measurement of IT technology and systems can be accomplished by use of this invention's programs and modules. The user can do its own self assessment through the available programs including IT spending, IT assets, and IT contracts. A program for scoring the achievements is provided as well as benchmarking.

The IT system of this preferred embodiment of the invention can comprise the following databases: an information technology planning database, an information technology purchasing database, an information technology managing database and an information technology optimizing database. Under one preferred system, the information technology planning database comprises strategic technology planning and budgeting data; identification and evaluation of strategic technology opportunities data; prioritizing technology projects and investments data; management of IT plans and budgets data; data for advising executive management on IT issues, data for updating and educating company boards on IT issues, business case analysis instructional data and models, product development instructional data and models, threat instructional data and models, and combinations thereof. The various business case analysis software programs comprise instructional text, models and interactive software relating to the how-to for developing a business case analysis and then performing the management activity using the online tools provided.

The information technology purchasing database can include data for evaluation of technology vendors and products, for one example, purchasing decisions and recommendations data; and how-to data for negotiating and administrating IT contracts.

Preferably, the information technology managing database comprises implementation of new technology data; management of existing technology data; data for management of IT plans and budgets, IT policies and procedures data, data for implementation of system upgrades and new releases, data for managing LANs, WANs, Datacomm, and Telecomm, data for managing systems capacity and availability, data for tracking and controlling IT assets, data for managing EDP Auditors and Regulators, data for manage Security and Risk, data for the management of vendors, end user IT support data, data for recruiting and training IT staff.

Information technology optimizing databases can comprise data for reevaluating and analyzing the success of IT purchases and personnel. The data includes information to maximized the potential for the IT purchases as well as data for launching new products for financial institutions, peer group comparison data, data to measure IT value, data for implementing new systems, data for activating current systems, data for enhancing current systems, process improvement data, information design and development data, application design and development data, and data for implementing financial institution IT training programs.

A communications network system for linking the one or more internet access devices to the one or more host servers is provided as is a database management system for accessing the one or more stored information technology management databases. In one aspect, the system can be available on-line, either on a local computer network or through the World Wide Web (hereinafter WWW) and is secured and available only to password protected users. This invention's IT management system can be available to many users at one time and can meet whatever storage capacity is needed for each user. Preferably, each client company or organization has a secured location on the web site. Alternatively, the communication network system comprises an Internet communication network system utilizing a high security Internet service provider connected to one or more remote servers for providing access to the web. In this embodiment, an interactive website accessible to authorized users can be stored on a highly secure remote server. In one embodiment of the present invention, the user accesses the website via the Internet. The homepage for the website can reside on a host server such as an ISP (Internet Service Provider) and can comprise an introductory splash screen along with links to information about the site and its services, contact information, and membership application for joining the IT management service. The visitor to the website cannot access further screens without authentication.

The interactive website, in this preferred embodiment, is located on a dedicated web server that receives, stores and sends information data, and communicates with the communications network system. Upon request for use of the IT management system, the interactive website software is programmed to initially authenticate the user by requesting and receiving authorization information such as client identification, passwords, or other means of identification from the requesting user's workstation. An alternative method of securing access to the website, or means for authenticating, is sophisticated bodyscan coding. Bodyscan coding uses the client's eye, finger or hand prints to identify the service provider as an authorized user. The service provider's computer can be adapted to scan the body part and transmit the information to the website host computer which matches the scan to a list of authorized service providers. Other methods of identifying the service provider so that only authorized users can access the sensitive information on the host website can also be used to limit access.

Encryption means can be performed by encryption software or hardware encryption devices that are known in the art. Encryption as use in reference to this invention is any procedure that converts data into a form that prevents anyone but the intended recipient from reading the encrypted data. Both Netscape's® Navigator™ and Microsoft's® Internet Explorer™ have encryption built in and automatically use it whenever transmitting data over a secure network. Preferably, other secure encryption programs can be used to ensure that access to the IT management service website, other than the homepage, is limited to authorized users. Alternatively, host Internet server systems are available that can provide a secured website. One such fully functional Internet server system is marketed under the trademark, VSERVER□.

Internet access devices are well known in the art and can comprise P.C's, computer terminals, hand held computers, Web T.V., wireless internet access devices, mobile internet access devices and combinations thereof. One or more internet access devices are used for accessing data stored on the host server.

In one preferred method for providing information technology management services, a web site comprising one or more information technology management databases is provided. The web site can be accessed using one or more internet access devices as listed above as well as a telephony gateway adapted to route telephone calls through the communications network system. Once the database management system located on the web site is accessed, users can communicate with information technology management consultants for optimizing the implementation of the IT managing database. Authorized users are authenticated prior to obtaining access to the web site.

The foregoing description is illustrative and explanatory of preferred embodiments of the invention, and variations in the size, shape, materials and other details will become apparent to those skilled in the art. It is intended that all such variations and modifications which fall within the scope or spirit of the appended claims be embraced thereby.

1. A system for providing information technology management support comprising:
(a) a web site hosted by a server, the web site comprising one or more information technology management modules;
(b) one or more internet access devices for accessing data stored on the host server;
(c) a communications network system for linking the one or more internet access devices to the one or more host servers; and
(d) a software management system for accessing the one or more stored information technology management software modules.

2. The system of claim 1 wherein the one or more software modules comprise one or more strategic technologies software modules, one or more infrastructure technologies software modules, one or more risk and regulatory management software modules and one or more IT management software modules.

3. The system of claim 2 wherein the IT management software modules comprises implementation of new technology data; management of existing technology data; data for management of IT plans and budgets, IT policies and procedures data, data for implementation of system upgrades and new releases, data for managing LANs, WANs, Datacomm, and Telecomm, data for managing systems capacity and availability, data for tracking and controlling IT assets, data for managing EDP Auditors and Regulators, data for manage Security and Risk, data for the management of vendors, end user IT support data, data for recruiting and training IT staff.

4. The system of claim 2 wherein the one or more strategic technologies software modules comprise industry specific software for the evaluation, selection, installation and utilization of industry specific technologies.

5. The system of claim 4 wherein the industry is financial services and the software comprises financial institution specific technologies comprising Internet banking, core accounting, CRM and cash management.

6. The system of claim 2 wherein the one or more infrastructure technologies software modules comprise software for the design, selection, installation and utilization of network, telecom, and datacom infrastructure technologies.

7. The system of claim 2 wherein the one or more risk and regulatory management software modules comprise IT risk management software, management of regulatory compliance software, and management of regulatory compliance data, information, or topics.

8. The system of claim 2 wherein the one or more IT management software modules comprise IT planning software, IT budgeting software, IT vendor management software IT vendor management software, IT cost control software, and IT cost control data, information, or topics.

9. The system of claim 1 further comprising one or more components to support the one or more information technology management software modules.

10. The system of claim 9 wherein the one or more components comprise reports, peer exchange, solution sourcing, tools, advice and support and combinations thereof.

11. The system of claim 10 wherein the reports component comprises research reports regarding IT management.

12. The system of claim 10 wherein the peer exchange component comprises software for the exchange of industry specific IT management information, practices, documents, methodologies and templates by industry members.

13. The system of claim 10 wherein the solution sourcing component comprises decision making informational data regarding IT matters.

14. The system of claim 10 wherein the tools component comprises decision support software.

15. The system of claim 10 wherein the advice and support component comprises customer support.

16. The system of claim 15 wherein the customer support comprises online, telephonic or in-person support.

17. The system of claim 1 wherein the one or more internet access devices comprise P.C's, computer terminals, hand held computers, Web T.V., wireless internet access devices, mobile internet access devices and combinations thereof.

18. The system of claim 1 wherein the communications network system comprises a local area network system.

19. The system of claim 1 wherein the communications network system comprises the Internet with access to the WWW.

20. The system of claim 1 further comprising an authorization system for authenticating authorized users.

21. A system for providing information technology management support comprising:
(a) a web site hosted by a server, the web site comprising one or more information technology management databases;
(b) one or more internet access devices for accessing data stored on the host server;
(c) a communications network system for linking the one or more internet access devices to the one or more host servers; and
(d) a software management system for accessing one or more stored information technology management software modules,
wherein the one or more software modules comprise one or more strategic technologies software modules, one or more infrastructure technologies software modules, one or more risk and regulatory management software modules and one or more IT management software modules.

22. The system of claim 21 wherein the IT management software modules comprises implementation of new technology data; management of existing technology data; data for management of IT plans and budgets, IT policies and procedures data, data for implementation of system upgrades and new releases, data for managing LANs, WANs, Datacomm, and Telecomm, data for managing systems capacity and availability, data for tracking and controlling IT assets, data for managing EDP Auditors and Regulators, data for manage Security and Risk, data for the management of vendors, end user IT support data, data for recruiting and training IT staff.

23. The system of claim 21 wherein the one or more strategic technologies software modules comprise industry specific software for the evaluation, selection, installation and utilization of industry specific technologies.

24. The system of claim 23 wherein the industry is financial services and the software comprises financial institution specific technologies comprising internet banking, core accounting, CRM and cash management.

25. The system of claim 21 wherein the one or more infrastructure technologies software modules comprise software for the design, selection, installation and utilization of network, telecom, and datacom infrastructure technologies.

26. The system of claim 21 wherein the one or more risk and regulatory management software modules comprise IT risk management software, management of regulatory compliance software, and management of regulatory compliance data, information, or topics.

27. The system of claim 21 wherein the one or more IT management software modules comprise IT planning software, IT budgeting software, IT vendor management software, IT cost control software, and IT cost control data, information, or topics.

28. The system of claim 21 further comprising one or more components to support the one or more information technology management software modules.

29. The system of claim 28 wherein the one or more components comprise reports, peer exchange, solution sourcing, tools, advice and support and combinations thereof.

30. A method for providing information technology management services comprising:
(a) providing a web site comprising one or more information technology management software modules;
(b) accessing the web site using one or more internet access devices;
(c) accessing a software management system located on the web site, the software management system comprising information technology management software modules;
(d) supporting an information technology program based on data provided by the information technology management software modules; and
(e) communicating with information technology management consultants for optimizing the support of the IT managing software.

31. The method of claim 30 wherein accessing the web site comprises using a communications network system comprising a local area network system.

32. The method of claim 30 wherein accessing the web site comprises using a communications network system comprising the Internet.

33. The method of claim 30 further comprising a means for authenticating authorized users.

34. The method of claim 30 wherein the website further comprises a dedicated web server.

35. The method of claim 30 wherein the website further comprises encryption means.

36. The method of claim 30 further comprising a telephony gateway adapted to route telephone calls through the communications network system.

37. The method of claim 30 wherein the information technology management software modules comprise one or more strategic technologies software modules, one or more infrastructure technologies software modules, one or more risk and regulatory management software modules and one or more IT management software modules.

38. The system of claim 30 further comprising one or more components to support the one or more information technology management software modules.

39. The system of claim 38 wherein the one or more components comprise reports, peer exchange, solution sourcing, tools, advice and support and combinations thereof.
